(19) United States
(12) Patent Application Publication
(10) Pub. No.: US 2019/0359437 A1
(43) Pub. Date: Nov. 28, 2019

(54) Rail Transport System

(71) Applicant: IP FULL ASSET LIMITED, Hong Kong (CN)

(72) Inventor: Tim Meyer-Dulheuer, Kronberg (DE)

(73) Assignee: IP FULL ASSET LIMITED, Hong Kong (CN)

(21) Appl. No.: 16/472,965

(22) PCT Filed: Nov. 7, 2017
(86) PCT No.: PCT/IB2017/056953

§ 371 Date: Jun. 24, 2019

(30) Foreign Application Priority Data
Dec. 23, 2016 (CN) 201611209617.X

(51) Int. Cl. B65G 67/20; B65G 1/04

(52) U.S. Cl. CPC B65G 67/20; B65G 1/0478

(57) ABSTRACT

A rail transport system comprising at least the following components: A loading/unloading field on each side of the transport system, wherein each loading/unloading field comprises a plurality of two-directional loading/unloading modules with at least two longitudinal shaped profile running rails and at least two lateral shaped profile running rails, wherein the two-directional loading/unloading modules are connected to each other; a transport field, wherein the transport field comprises a large number of uni-directional transport modules, wherein each transport module comprises two longitudinal shaped profile running rails and each unidirectional transport module is connected with a loading/unloading module on each side of the transport system and a transportation cart which is moved along the longitudinal direction.

### BACKGROUND OF THE INVENTION

The current invention is related to a rail transport system, particularly a rail transport system for loading and unloading cargos, such as trolleys for an airplane.

The European patent, EP 2627597 B1, describes a rail transport system for loading and unloading an airplane galley. The transport system comprises two shaped-profile running rails, a transport rail and a transport cart, wherein the transport cart is loaded with trolleys and is moved on the transport rail. In addition, the patent also discloses a system for concurrently loading the galley of an aircraft, which comprises a truck case, two rail transport systems between the truck case and the aircraft cabin and several rail transport systems within the truck case for the transport of the transport trolley within the truck case. However, the transport rails described in EP 2627597 B1 only allow the transport cart to move back and forth in one direction.

From U.S. Pat. No. 4,424,050 a cargo tray for use in an aircraft is known which makes it possible to fasten the freight in the cargo department safely. A system for shifting a cargo truck and its subsequent transport into the galley of an aeroplane are not described.

From the German Patent application DE 197 56 551 A1 a loading system for trucks is known which allows an arrangement of the cargo during the journey which makes it possible that even by a change of the sequence of the customers the cargo may be unloaded in a time-saving manner.

Moreover in the German utility model DE 200 16 115 U1 a modular connected cargo floor is known, wherein several floor parts are combined. A shifting of a transport vehicle to the floor of a truck and the subsequent transport into the galley of an aeroplane is not disclosed there.

The object of the present invention is to provide a rail transport system which allows the transport cart to move back and forth not only in a longitudinal direction but also in a lateral direction, which offers more flexibility for the transportation of the cargo.

### SUMMARY OF THE INVENTION

The rail transport system according to the present invention comprises at least a loading/unloading field on each side of the transport system, a transportation field and a transport cart. Each loading/unloading field comprises a plurality of two-directional loading/unloading modules respectively, wherein each two-directional loading/unloading module comprises at least two longitudinal shaped-profile running rails and at least two lateral shaped-profile running rails. The two-directional loading/unloading modules are connected to each other such that the lateral shaped-profile running rails of one two-directional module are connected with the lateral shaped-profile running rails of the neighboring two-directional module or modules. The transportation cart is moved along the running rails.

Each of the two-directional loading/unloading modules has at least two shaped-profile running rails which are parallel to each other and are positioned in the longitudinal direction and at least two shaped-profile running rails which are parallel to each other and positioned in the lateral direction. The term “two-directional” means that the at least two sets of running rails located in the loading/unloading are extended in two different directions and these two directions are preferably vertical to each other, namely, one direction is longitudinal and one direction is lateral. In this way, the transportation cart can move along the longitudinal as well as the lateral directions.

The two-directional loading/unloading modules are placed beside each other and can be connected to each other with screws. The two-directional loading/unloading modules are connected to each other such that the lateral shaped-profile running rails of one two-directional module are connected with the lateral shaped-profile running rails of the neighboring two-directional module or modules. In this way, the transportation carts can be moved laterally, so that they can be positioned first into the longitudinal running rails, along which they are to be transported. This is one of the advantages of the present invention, since the lateral position of each transportation cart, according to the present invention, can be first adjusted before the cart is moved along the longitudinal direction.

Preferably, each loading/unloading field contains two or more rows of the two-directional loading/unloading modules, wherein each two-directional loading/unloading module is connected with the neighboring two-directional loading/unloading module of the neighboring row in a way such that the longitudinal shaped-profile running rails of one loading/unloading module are connected with the longitudinal shaped profile running rails of the neighboring two-directional module(s). The current invention provides the transportation of carts with more flexibility. The transportation carts can be moved in lateral direction and be first positioned into the desired longitudinal running rails before they are transported in the transportation field. Before they are unloaded, they can also be positioned into the desired lateral position which corresponds with the loading/unloading ramp, so that they can be easily unloaded via the loading/unloading ramp.

Preferably, each two-directional loading/unloading module further comprises at least one gear wheel which turns along the latitudinal direction and at least one gear wheel which turns along the lateral direction. Moreover, each two-directional loading/unloading module contains a motor which drives the gear wheel along the latitudinal direction and a motor which drives the gear wheel along the longitudinal direction. By turning on and off motors, the transport cart can be controlled to move in both directions.

Likewise, each mono-directional transportation module also preferably comprises further at least one electric motor and at least one gear wheel which turns along the longitudinal direction, in order to enable the movement of the transport cart in the longitudinal direction.

The transport cart of the current invention comprises a plate for carrying trolleys. It is important for the transport cart of the current invention to have gear racks on the bottom of the plate. The gear racks are positioned to match with the gear wheels of the two-directional and mono-directional modules, so that the transport cart can be driven by the motor and the gear wheel to move either along the longitudinal or the lateral direction.

Preferably, the rail transport system further comprises a loading ramp, wherein the loading ramp is composed of at least two two-directional loading/unloading modules and the loading ramp is connected with the loading/unloading field in a way such that the longitudinal shaped-profile running rails of each module are connected with the longitudinal shaped-profile running rails of the neighboring two-directional loading/unloading module. Preferably, each of the two-directional loading/unloading modules further comprises at least one electric motor and at least one gear wheel along the latitudinal direction and at least one gear wheel along the lateral direction, in order to enable the movement of the transport cart in both directions.

Preferably the loading ramp is connected with the two-directional loading/unloading module of the loading/unloading field and can be unfolded when used for loading and unloading.

The rail transport system can be used in a variety of scenarios. It can be used in a warehouse, a truck box, and etc. When it is used for forward loading and reverse unloading of lift truck boxes, a loading ramp is necessary. The loading ramp serves to load or unload the transport cart. The loading ramp comprises preferably only two two-directional loading/unloading modules. Since the transport cart can move laterally in the loading/unloading field due to the presence of both lateral and longitudinal running rails, the transport cart can be directed exactly to the loading ramp for unloading or the transport carts can be dissipated laterally to give space for the next cart for loading, which provides tremendous convenience and flexibility.

Preferably, all of the shaped-profile running rails of the present invention are U-shaped running rails with the open top partially covered from both sides. This particular shape of running rails stabilizes the transport cart during transportation and prevents the transport cart from tipping over.

Preferably, each loading/unloading module and each transportation module are covered with a plate to protect the electric motor, wherein the plate is provided with openings to expose the corresponding gear wheels.

Preferably, each mono-directional transportation module on the transportation field of the rail transport system of the present invention comprises a plurality of rail sections. On a transport rail that is made of a plurality of rail sections, two adjoining rail sections are preferably connected by a pivot joint that makes it possible to fold the transport rail together. On a telescopic transport rail that is made of a plurality of rail sections, preferably, the transport rail has a telescopic device that is operated by the electric motor. The rail sections are connected to each other in a telescopic fashion, and the telescopic device is able to push the transport rails section by section, using a gear mechanism.

The electric motor of the rail transport system of the present invention can each be operated by a rechargeable battery. The rechargeable battery can be charged by the alternator on the truck/lift truck.

### BRIEF DESCRIPTION OF THE DRAWINGS

Figures:

FIG. 1 is a top view of the rail transport system of the present invention.

FIG. 2 is a top view of a two-directional loading/unloading module of the present invention without motors and gear wheels.

FIG. 3 is a top view of the two-directional loading/unloading module in FIG. 2 filled with a motor and gear wheels in the longitudinal direction.

FIG. 4 is a top view of the two-directional loading/unloading module in FIG. 3 further filled with a motor and gear wheels in the lateral direction.

FIG. 5 is a top view of the two-directional loading/unloading module in FIG. 4, wherein the module is covered with a plate with openings to expose the corresponding gear wheels.

FIG. 6 shows the two-directional loading/unloading modules in FIG. 5 lining together to form the loading/unloading field of the present invention.

FIG. 7.1 shows the bottom view of the power unit of the two-directional loading/unloading module in the longitudinal direction in FIG. 4.

FIG. 7.2 shows the side view of the gear wheel in FIG. 8.1.

FIG. 8 shows the loading ramp of the rail transport system of the present invention.

FIG. 9 shows the side view of the bottom plate of the transport cart.

FIG. 10 shows the transport carts carrying trolleys moving on the rail transport system of the present invention.

FIG. 11 shows one of the applications of the rail transport system of the present invention.

### LIST OF REFERENCE SIGNS

1, 2: Loading/unloading field

3: transportation field

4, 5: two-directional loading/unloading module

6: mono-directional transportation module

7: longitudinal shaped-profile running rail of the two-directional loading/unloading module

8: lateral shaped-profile running rail of the two-directional loading/unloading module

9: gear wheels in the longitudinal direction

10: transmission gear

11: gear wheels in the lateral direction

12: motor for gear wheels in the longitudinal direction

13: drive gears

14: cover plate

15: longitudinal shaped-profile running rail of the mono-directional transportation module

16: motor for gear wheels in the lateral direction

17: bottom plate of the transport cart

18: crossing of two gear tracks in longitudinal and lateral directions

19: loading ramp

20: trolley

21: transport cart

22: truck box

23: gear rack

### DETAILED DESCRIPTION

### Embodiments

Further advantages and details of the present invention are illustrated as follows based on the embodiments as shown in the drawings, which are in no way intended to limit the protective scope of the invention.

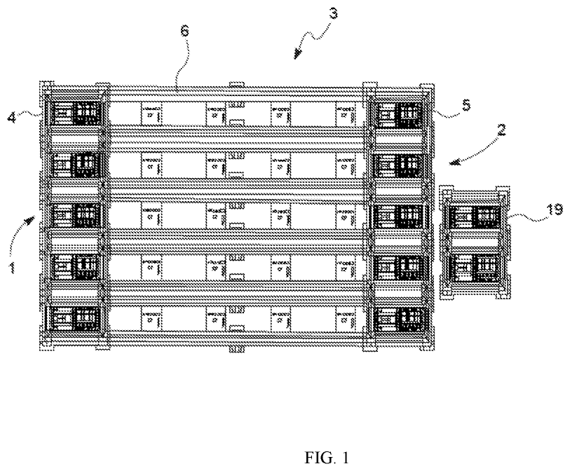

FIG. 1 is a top view of the rail transport system according to one embodiment of the present invention. The rail transport system comprises on each side a loading/unloading field 1, 2, a transportation field 3 and a loading ramp 19. Each loading/unloading field 1, 2 comprises a plurality of two-directional loading/unloading modules 4, 5 respectively. The transportation field comprises a plurality of mono-directional transportation modules 6. Each two-directional loading/unloading module comprises at least two longitudinal shaped-profile running rails and at least two lateral shaped-profile running rails, wherein the two-directional loading/unloading modules are connected to each other such that the lateral shaped-profile running rails of one two-directional module are connected with the lateral shaped-profile running rails of the neighboring two-directional module(s). Each transportation module comprises two longitudinal shaped-profile running rails, wherein each mono-directional transportation module is connected with one loading/unloading module on each side of the transport system such that the longitudinal shaped-profile running rails of the transportation module are connected with the neighboring longitudinal shaped-profile running rails of the loading/unloading modules respectively.

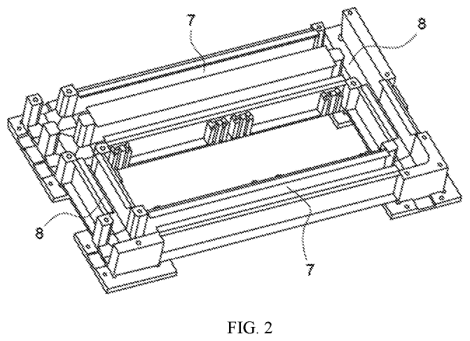

FIG. 2 is a top view of a two-directional loading/unloading module of the present invention without motors and gear wheels. Each two-directional loading/unloading module comprises at least two longitudinal shaped-profile running rails 7 and at least two lateral shaped-profile running rails 8.

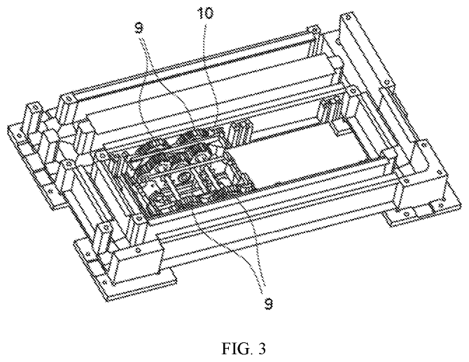

FIG. 3 is a top view of the two-directional loading/unloading module in FIG. 2 filled with a motor (not clearly illustrated) and gear wheels 9 in the longitudinal direction. The transmission gear 10 increases torque and adjusts the revolution speed of the gear wheels.

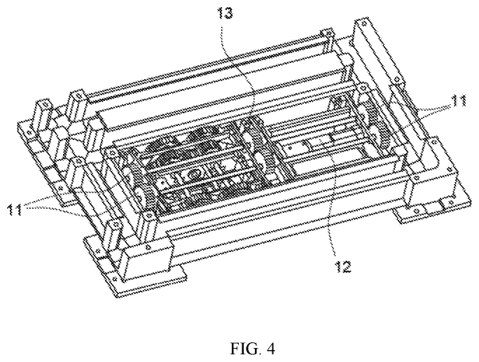

FIG. 4 is a top view of the two-directional loading/unloading module in FIG. 3 further filled with a motor 12 and gear wheels 11 both in the lateral direction. The motor 12 drives the gear wheels 11 through the drive gears 13 of the shafts.

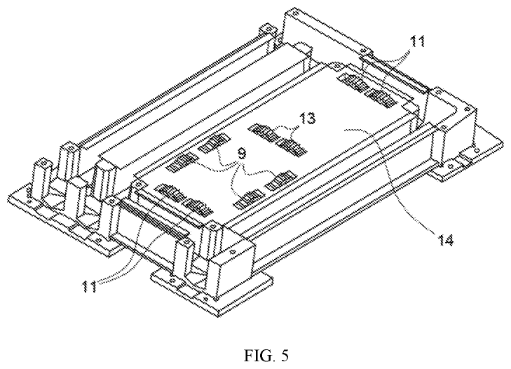

FIG. 5 is a top view of the two-directional loading/unloading module in FIG. 4, wherein the module is covered with a plate 14 with openings to expose the corresponding gear wheels 9, 11 and drive gears 13.

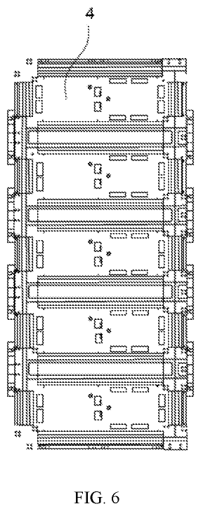

FIG. 6 shows the two-directional loading/unloading modules 4 in FIG. 5 lining together to form the loading/unloading field of the present invention.

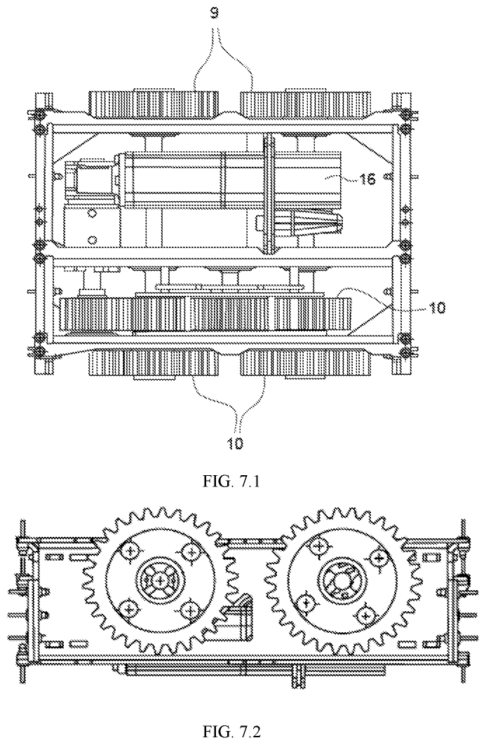

FIG. 7.1 shows the bottom view of the power unit of the two-directional loading/unloading module in the longitudinal direction in FIG. 4. The module contains gear wheels 9, a motor 16 and transmission gears 10.

FIG. 7.2 shows the side view of the gear wheel 9 in FIG. 7.1.

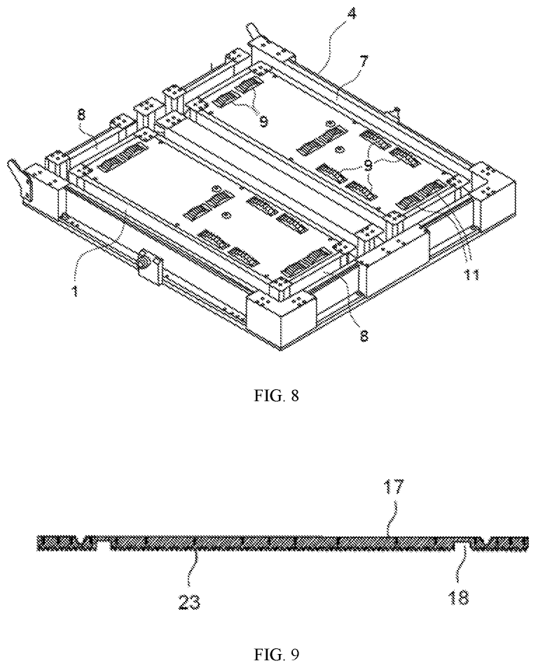

FIG. 8 shows the loading ramp of the rail transport system of the present invention. The loading ramp is composed of at least two two-directional loading/unloading modules 4, wherein each of the two-directional loading/unloading modules 4 further comprises two electric motors (not shown) and one set of gear wheels along the longitudinal direction 9 and at least one gear wheel along the lateral direction 11, in order to enable the movement of the transport cart in both directions. Each two-directional loading/unloading module comprises at least two longitudinal shaped-profile running rails 7 and at least two lateral shaped-profile running rails 8, wherein the two-directional loading/unloading modules are connected to each other such that the lateral shaped-profile running rails 8 of one two-directional module are connected with the lateral shaped-profile running rails 8 of the neighboring two-directional module. Each module is covered with a plate with openings to expose the corresponding gear wheels 9, 11 and drive gears 13.

FIG. 9 shows the side view of the bottom plate 17 of the transport cart. The bottom of the bottom plate 17 of the transport cart is provided with gear racks 23 that are positioned to match with the gear wheels of the two-directional and mono-directional modules. The figure also shows crossings 18 of two gear tracks in longitudinal and lateral directions.

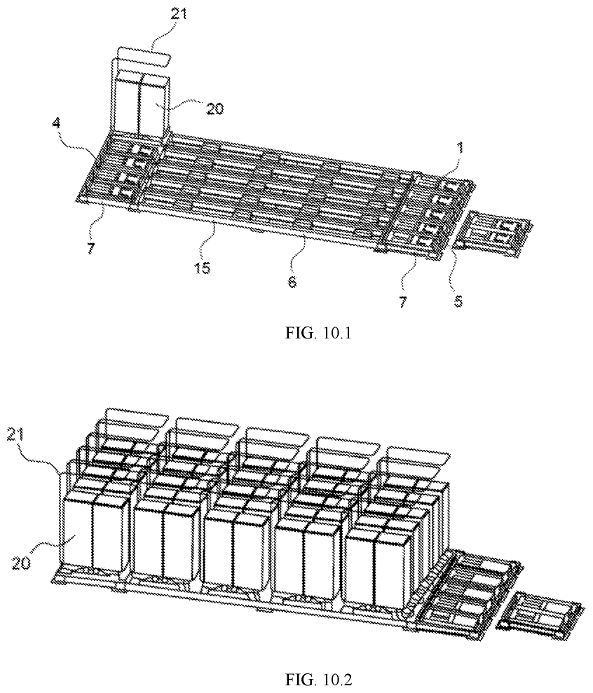

FIG. 10 shows the transport carts 21 carrying trolleys 20 moving on the rail transport system of the present invention. Each mono-directional transportation module 6 is connected with one loading/unloading module 4, 5 on each side of the transport system such that the longitudinal shaped-profile running rails 15 of the transportation module are connected with the neighboring longitudinal shaped-profile running rails 7 of the loading/unloading modules respectively, so that the transport cart 21 can move between the loading/unloading field and the transportation field in the longitudinal direction.

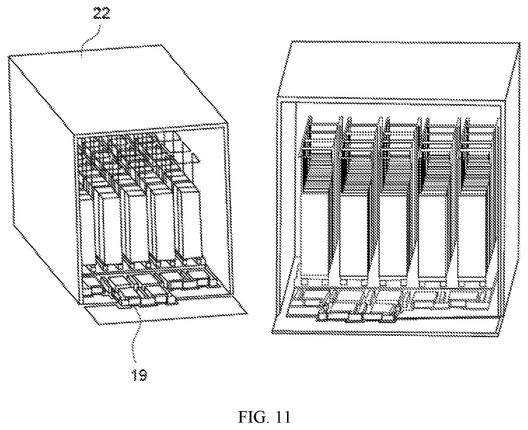

FIG. 11 shows how the rail transport system of the present invention is used for loading and unloading of a truck box 22 with trolleys. The loading ramp 19 is composed of at least two two-directional loading/unloading modules and the loading ramp 19 is connected with the loading/unloading field in a way such that the longitudinal shaped-profile running rails of each module are connected with the longitudinal shaped-profile running rails of the neighboring two-directional loading/unloading module, so that the transport carts can be loaded into and unloaded from the truck box.

What is claimed is:

1. A rail transport system comprising:
a. a loading/unloading field on each side of the transport system, wherein each loading/unloading field comprises a plurality of two-directional loading/unloading modules respectively, wherein each two-directional loading/unloading module comprises at least two longitudinal shaped-profile running rails and at least two lateral shaped-profile running rails, wherein the two-directional loading/unloading modules are connected to each other such that the lateral shaped-profile running rails of one two-directional module are connected with the lateral shaped-profile running rails of the neighboring two-directional module(s);
b. a transportation field, wherein the transportation field comprises a plurality of mono-directional transportation modules, wherein each transportation module comprises two longitudinal shaped-profile running rails, and wherein each mono-directional transportation module is connected with one loading/unloading module on each side of the transport system such that the longitudinal shaped-profile running rails of the transportation module are connected with the neighboring longitudinal shaped-profile running rails of the loading/unloading modules respectively; and
c. a transport cart, which is moved along the running rails.

2. The rail transport system according to claim 1, characterized in that each loading/unloading field contains two or more rows of the two-directional loading/unloading modules, wherein each two-directional loading/unloading module is connected with the neighboring two-directional loading/unloading module of the neighboring row in a way such that the longitudinal shaped-profile running rails of one loading/unloading module are connected with the longitudinal shaped profile running rails of the neighboring two-directional module(s).

3. The rail transport system according to claim 1, characterized in that each two-directional loading/unloading module further comprises at least one electric motor and at least one gear wheel along the longitudinal direction and at least one gear wheel along the lateral direction, in order to enable the movement of the transport cart in both directions.

4. The rail transport system according to claim 1, characterized in that each mono-directional transportation module comprises further at least one electric motor and at least one gear wheel along the longitudinal direction, in order to enable the movement of the transport cart in the longitudinal direction.

5. The rail transport system according to claim 1, characterized in that the rail transport system further comprises a loading ramp, wherein the loading ramp is composed of at least two two-directional loading/unloading modules and the loading ramp is connected with the loading/unloading field in a way such that the longitudinal shaped-profile running rails of each module are connected with the longitudinal shaped-profile running rails of the neighboring two-directional loading/unloading module, and wherein each of the two-directional loading/unloading modules further comprises at least one electric motor and at least one gear wheel along the longitudinal direction and at least one gear wheel along the lateral direction, in order to enable the movement of the transport cart in both directions.

6. The rail transport system according to claim 5, characterized in that the loading ramp is hinged connected with the two-directional loading/unloading module of the loading/unloading field and can be unfolded when used for loading and unloading.

7. The rail transport system according to claim 1, characterized in that all of the shaped-profile running rails are U-shaped running rails with the open top partially covered from both sides.

8. The rail transport system according to claim 1, characterized in that each loading/unloading module and each transportation module are covered with a plate to protect the electric motors, wherein the plate is provided with openings to expose the corresponding gear wheels.

9. The rail transport system according to claim 1, characterized in that the transport cart comprises a plate for carrying trolleys, wherein the bottom of the plate is provided with gear racks that are positioned to match with the gear wheels of the two-directional and mono-directional modules.

10. The rail transport system according to claim 1, characterized in that each mono-directional transportation module comprises a plurality of foldable rail cassettes or a telescopic rail section.
